(19) United States
(12) Patent Application Publication
(10) Pub. No.: US 2003/0158920 A1
(43) Pub. Date: Aug. 21, 2003

(54) Method, system, and program for supporting a level of service for an application

(75) Inventors: Amy Elizabeth Lynch, Los Altos, CA (US); Mark A. Carlson, Boulder, CO (US)

Correspondence Address: KONRAD RAYNES VICTOR & MANN LLP, Suite 210, 315 S. Beverly Drive, Beverly Hills, CA, 90212, US

(73) Assignee: Sun Microsystems, Inc.

(21) Appl. No.: 10/357,554

(22) Filed: Feb. 4, 2003

Related U.S. Application Data
(60) Provisional application No. 60/355,611, filed on Feb. 5, 2002.

(51) Int. Cl. G06F 15/177

(52) U.S. Cl. 709/220; 709/223

(57) ABSTRACT

Disclosed is a technique for supporting an application. Software and hardware layers are integrated to form an integrated storage area management system. A level of service is determined for the application. A template is created for each data type of data used by the application, wherein each template identifies characteristics associated with the level of service for the application. Data is gathered from the software and hardware layers. Requests from the application are processed using the gathered data.

### CROSS-REFERENCE TO PROVISIONAL APPLICATION

This application is a non-provisional application claiming priority from the following pending application:

U.S. Provisional Application No. 60/355,611, entitled “INTEGRATED AND AUTOMATED STORAGE MANAGEMENT,” by Amy Lynch, filed on Feb. 5, 2002, and which is incorporated by reference herein in its entirety.

### BACKGROUND OF THE INVENTION

1. Field of the Invention

The present invention is related to supporting a level of service for an application.

2. Description of the Related Art

Several market forces have been taking their toll on Information Technology (IT) staffs and their ability to keep pace with storage growth, management, and infrastructure complexity. These factors have primarily arisen from the increased reliance on the Internet to conduct e-business and e-commerce, in addition to the growth of databases and unstructured data (e.g., multimedia and document attachments). In the past, to combat this demand for storage, companies were quick to add more capacity since the cost/megabyte of storage had been steadily falling. With the recent economic downturn, however, IT budgets have fallen under scrutiny and IT managers have been forced to defer IT purchases and do more with less. The economic downturn has also resulted in IT staff hiring freezes. Consequently, the amount of capacity managed per company has in some cases doubled, while the number of IT administrators responsible for managing that capacity has not.

Compounding this problem further has been the adoption of new storage architectures such as storage area networks (SANs) and network attached storage (NAS), which introduce a new level of complexity. IT staffs are faced with managing heterogeneous storage, systems, and networked enterprise with minimal staff levels, skills, and tools. Without automated solutions to proactively monitor, report, and manage this growth, return on storage investment will be poor and application storage service levels will suffer.

A storage area network (SAN) comprises a network linking one or more servers to one or more storage systems. Each storage system could comprise a Redundant Array of Independent Disks (RAID) array, tape backup, tape library, CD-ROM library, or JBOD (Just a Bunch of Disks) components. Storage area networks (SAN) typically use the Fibre Channel protocol, which uses optical fibers to connect devices and provide high bandwidth communication between the devices. In Fibre Channel terms the one or more switches interconnecting the devices is called a “fabric”. However, SANs may also be implemented in alternative protocols, such as InfiniBands™, IPStorage over Gigabit Ethernet, etc.

There has been a recent emphasis on improving application storage service levels either through outsourced managed service providers or an internal IT department. The term “application storage service level” refers to levels of storage service required for the application. For example, if an application requests storage, and if the level of storage service for that application indicates that high performance storage is required for that application, the request is fulfilled with high performance storage. Allocation of storage to applications based on application storage service levels involves matching user demands with storage capacity, meeting corporate objectives of maximizing total cost of ownership (TCO), and meeting business objectives of achieving service level agreements (SLAs). With limited IT budgets, these objectives often cannot be met.

Thus, there is a need in the art for improved support for a level of service for an application.

### SUMMARY OF THE INVENTION

Provided is a technique for supporting an application. Software and hardware layers are integrated to form an integrated storage area management system. A level of service is determined for the application. A template is created for each data type of data used by the application, wherein each template identifies characteristics associated with the level of service for the application. Data is gathered from the software and hardware layers. Requests from the application are processed using the gathered data.

The described implementations of the invention provide a method, system, and program for providing an integrated and automated storage management solution focused on delivering a level of service for an application commensurate with the net value of the application. In particular, associations are created of business metrics, such as storage element costs and application service levels, to logical and physical storage resources. Then, applications and data generated by the applications are matched to the appropriate storage resources based on the application's business value.

### BRIEF DESCRIPTION OF THE DRAWINGS

Referring now to the drawings in which like reference numbers represent corresponding parts throughout:

FIG. 1 illustrates, in a block diagram, a computing environment in accordance with certain implementations of the invention.

FIG. 2 illustrates an integrated storage area management system in accordance with certain implementations of the invention.

FIG. 3 illustrates further details of the storage area management software in accordance with certain implementations of the invention.

FIGS. 4A, 4B, and 4C illustrate processing performed by a system administrator in accordance with certain implementations of the invention.

FIG. 5 illustrates a sample template in accordance with certain implementations of the invention.

FIG. 6 illustrates logic implemented by the storage area management software to collect data in accordance with certain implementations of the invention.

FIG. 7 illustrates logic implemented by the storage area management software to support application level storage management in accordance with certain implementations of the invention.

FIG. 8 illustrates one implementation of the architecture of the computer systems in accordance with certain implementations of the invention.

### DETAILED DESCRIPTION

In the following description, reference is made to the accompanying drawings which form a part hereof and which illustrate several implementations of the present invention. It is understood that other implementations may be utilized and structural and operational changes may be made without departing from the scope of the present invention.

Businesses are faced with the challenge of balancing quality of storage service with total cost of ownership to effectively monitor and measure service level agreements in expanding storage environments and to satisfy user requirements without compromising corporate objectives. Implementations of the invention provide an integrated and automated storage management solution focused on delivering a level of service for an application commensurate with the application's net value to the business.

Implementations of the invention provide a quality of service approach to providing higher levels of storage service (e.g., per a storage level agreement) for some applications (e.g., those that matter most to the business) and providing lower levels of storage service to other applications (e.g., those that do not warrant such performance levels). These implementations for classifying data used by applications based on their corporate asset value are automated and seamless (e.g., transparent to the user). The level of service required and the corresponding level of data protection and availability are defined, by, for example, a system administrator.

Storage Area Management (SAM) refers to the centralized management of resources and data across one or more storage domains that provide shared services to a group of servers and their applications.

Certain implementations of the invention use a family of storage management solutions that offer integrated storage area management capabilities. Certain implementations of the invention use software available from Sun Microsystems, Inc., but software available from any vendor may be used without departing from the scope of the invention. Implementations of the invention deliver integrated and automated storage management focused on delivering levels of service for applications commensurate with the net value of the applications to the business.

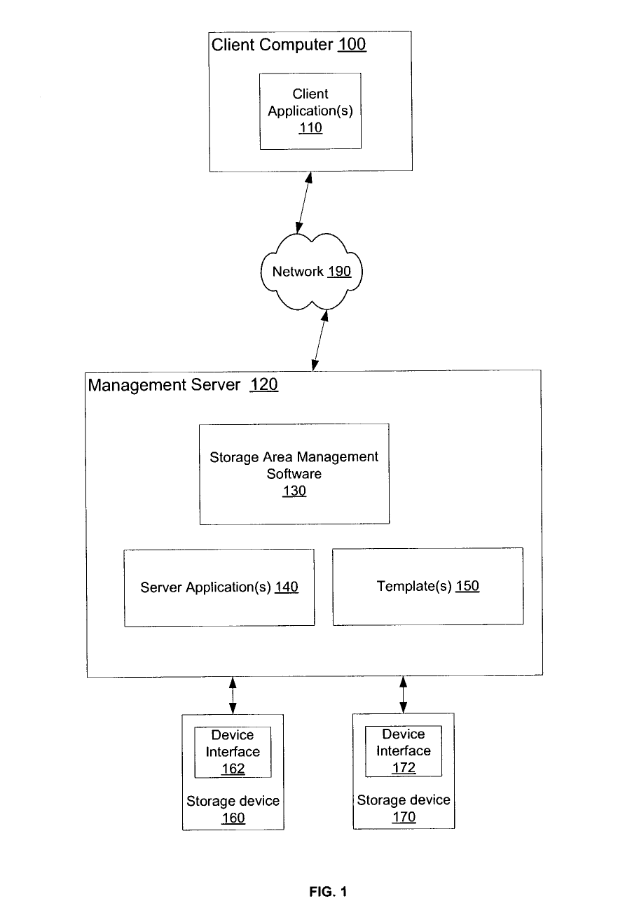

FIG. 1 illustrates, in a block diagram, a computing environment in accordance with certain implementations of the invention. A client computer 100 executes one or more client applications 110. A client application 110 may be any type of application program. The client computer 100 is connected to a management server 120 by a network 190, such as a local area network (LAN), wide area network (WAN), or the Internet. The Internet is a world-wide collection of connected computer networks (i.e., a network of networks).

The client applications 110 may access data managed by the management server 120. The management server 120 includes storage area management software 130 and one or more server applications 140. The storage area management software 130 includes software for supporting levels of service for applications. The server applications 140 include, for example, high availability applications and relational database management software. The client applications 110 and/or server applications 140 may use the storage area management software 130 to acquire information on storage (e.g., availability of particular storage) or to acquire storage. Additionally, a system administrator may use the storage area management software 130 to acquire information on storage.

The management server 120 includes one or more templates 150. Each template 150 may be associated with a data type (e.g., database log data type, database table data type, or configuration data type) for data used by one or more client and/or server applications 110, 140. If a client and/or server application 110, 140 uses data of different data types, there are multiple templates 150, with one template 150 being associated with each data type. Additionally, different instances of the same data type are associated with the template for that data type. For example, if there are five instances of database logs, with each instance being of the database log data type, then each of the five instances of database logs are associated with the same template (i.e., the template associated with the database log data type).

The storage area management software 130 uses the templates to recommend and/or provide data storage and other services to client and/or server applications 110, 140. In certain implementations of the invention, a template is a configuration policy as described in U.S. patent application Ser. No. 10/041,883, entitled “METHOD, SYSTEM, AND PROGRAM FOR CONFIGURING SYSTEM RESOURCES,” by Carlson et al., filed on Oct. 18, 2001, which is incorporated by reference herein in its entirety.

Moreover, the management server 120 is connected to storage devices 160, 170, and each storage device 160, 170 has a device interface 162, 172. For example, each storage device 160 and 170 may be a redundant array of independent disks (RAID). A RAID device enables storage of the same data on multiple hard disks, thus allowing simultaneous accesses to copies of the data.

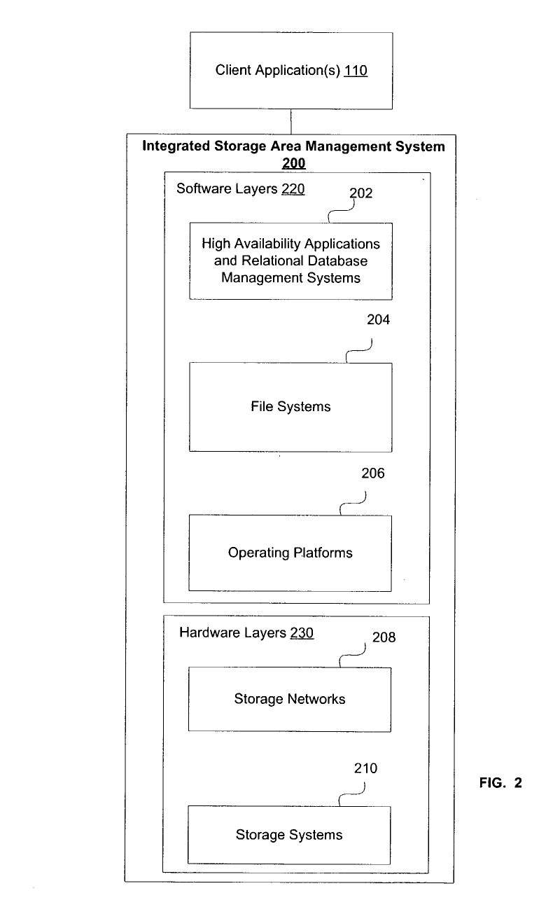

FIG. 2 illustrates an integrated storage area management system 200 in accordance with certain implementations of the invention. In particular, FIG. 2 illustrates a topological view of an enterprise storage environment. The integrated storage area management system 200 includes components used to support management of levels of service for applications. These components are separated into layers 220, 230 for ease of reference.

In particular, the integrated storage area management system 200 includes a stack of software and hardware layers 220, 230, respectively. A storage systems layer 210 and a storage networks layer 208 are hardware layers 230. An operating platforms layer 206 is a software layer 220 that includes operating systems. A file systems 204 layer is a software layer 220 including software for managing files. A high availability applications and relational database management systems layer 202 is a software layer 220 including applications for managing data. The high availability applications and relational database management systems are examples of server applications 140. The integrated storage area management system 200 extends the domain of storage management up from the storage systems layer 210 to an application layer 202, thereby merging the software (i.e., logical) and the hardware (i.e., physical) layers 220, 230, respectively, so that the storage area management software 130 can correlate how events lower in the stack of software and hardware layers 220, 230, respectively, affect application availability and performance-based software license agreements.

The integrated storage area management system 200 provides an automated integrated solution that allows application storage requests to be processed without a system administrator. The integrated storage area management system 200 also provides end-to-end storage area management to allow an application to dictate its own storage requirements (e.g., allocate storage for use by the application).

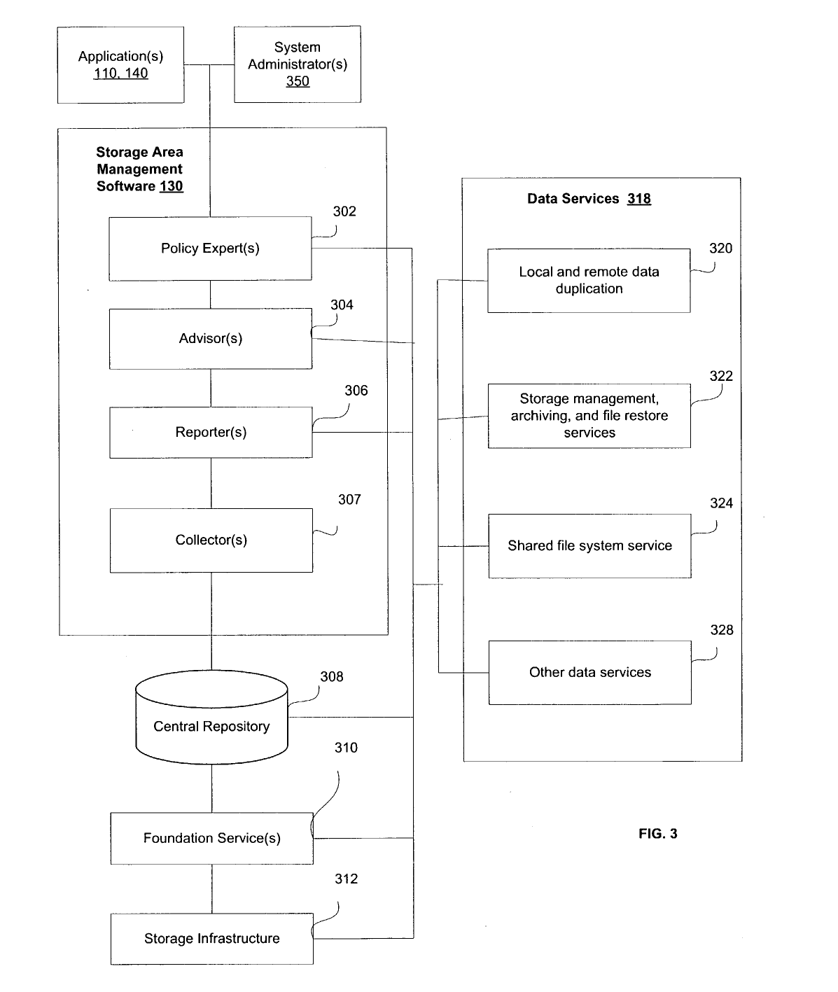

FIG. 3 illustrates further details of the storage area management software 130 in accordance with certain implementations of the invention. Applications 110, 140 and/or system administrators 350 access storage area management software 130. In certain implementations, the storage area management software 130 includes one or more collectors 307, one or more reporters 306, one or more advisors 304, and one or more policy experts 302. Each collector 307, reporter 306, advisor 304, and policy expert 302 may be individual software programs or may be combined in various ways (e.g., a reporter 306 and advisor 304 may be combined to form one software program). In certain implementations, the storage area management software 130 includes one or more foundation services 310 and/or data services 318.

The storage infrastructure 312 refers to physical storage, such as storage devices 160, 170. The storage infrastructure 312 is an example of hardware layers 230. Foundation services 310 include common services that may be used by higher level applications, for example, discovery of devices, event management, topology services, and logging. Foundation services 310 are an example of software layers 220.

A collector 307 gathers information from software and hardware layers 220, 230, respectively, and stores the information in the central repository 308. In certain implementations, the central repository 308 is an example of hardware layers 230. The software and hardware layers 220, 230, respectively, of the integrated storage area management system 200 are instrumented to respond to requests to data or to store data that may be retrieved by the collector 307. In certain implementations, the collector 307 gathers data from software and hardware layers 220, 230, respectively, through standard interfaces, such as interfaces defined by a Common Information Model (CIM) standard.

CIM is a standard for an object-oriented model for managing information. The CIM standard is provided by the Distributed Management TaskForce (DMTF), Inc. For further information on the CIM standard, see “Common Information Model (CIM) Specification,” Version 2.2, Jun. 14, 1999. Additional information is available in: “Specification for CIM Operations over HTTP,” Version 1.1, May 2, 2002, hereinafter referred to as “CIM specification,” which is incorporated by reference herein in its entirety.

A reporter 306 accesses the information stored in the central repository 308 and generates one or more reports. In particular, the reporter 306 generates queries that are submitted against the information in the central repository 308. The reporter 306 generates the queries based upon input received via a user interface from a system administrator.

In certain implementations, a Sun® StorEdge™ Resource Management Suite, available from Sun Microsystems, Inc., implements the functionality of the collector 307 and the reporter 306. In particular, the Sun® StorEdge™ Resource Management Suite provides automated monitoring, reporting and alerting of storage resource for proactively managing storage growth, implementing cost accounting and user chargeback, and planning for storage networks.

An advisor 304 generates queries that are submitted against the information in the central repository 308 and analyzes the information returned by the queries. Based on the analysis, the advisor 304 then provides advice (e.g., on which storage to allocate to an application) to, for example, a system administrator.

In certain implementations, a policy expert 302 may be used to analyze the information stored in the central repository 308, determine one or more actions to be implemented, and automatically implement one or more determined actions based on the analysis and based on predetermined policies (e.g., business policies that are identified in the templates).

Data services 318 interact with the integrated storage area management software 130. The data services are examples of software layers 220. The data services 318 include, for example: local and remote data replication 320; storage management, archiving, and file restore services 322; shared file system service 324; and, zero or more other data services 328. The data services 318 may include a variety of applications offered by different vendors (e.g., applications provided by Sun Microsystems, Inc., Oracle Corporation, International Business Machines Corporation, etc.).

The integrated storage area management system 200 initiates the convergence of visualization, virtualization, storage resource management, and application management to provide automated storage provisioning and service level management through an integrated management structure and set of services that provide application to data path management. That, is an application can manage a data path, which is the path along which data moves (e.g., a backup application moves data in the data path).

Implementations of the invention allow IT organizations to implement and measure differentiated service levels, including availability, performance, and security, while at the same time masking storage network complexity and enabling IT to focus on meeting application service levels.

Implementations of the invention reduce complexity and provide an integrated approach to storage management. In certain implementations, data services 318, including local and remote data replication 320, storage management, archiving, and file restore services 322, shared file system service 324, are part of a StorEdge™ family of storage management software suites available from Sun Microsystems, Inc. The family of storage management software suites provide customers with a packaging and pricing model which is less complex, that addresses specific customer problems, and that leverages the strengths of various software.

The StorEdge™ family includes software suites that provide a solutions based approach to customer problems and that simplify how customers can procure software. In certain implementations, local and remote data replication 320 is provided by Sung StorEdge™ Availability Suite that provides local or remote point-in-time copy and remote mirroring to reduce planned and unplanned business disruptions and speed disaster recovery. In certain implementations, storage management, archiving, and file restore services 322 are provided by Sung StorEdge™ Utilization Suite that provides automated storage management, archiving, and rapid file restores to maximize storage and IT staff utilization. In certain implementations, the shared file system service 324 is a Sun® StorEdge™ Performance Suite that provides a shared file system service with unparalleled data access speeds for applications where scalable, high-speed data access is required.

In certain implementations, levels of service for applications are supported with a set of software and hardware. The hardware includes storage that may be accessed or requested by an application. The software includes data reporting capability, as well as the capability to analyze reported data and suggest advice in responding to an application's request for storage. Furthermore, implementations of the invention offer the ability to automatically select one or more actions and implement these actions to respond to an application's request for storage. The described implementations reduce total cost of ownership (TCO) and maximize utilization; increase quality of storage service levels; improve continuous access to data for business continuity; and deliver quick data access for high-performance demands.

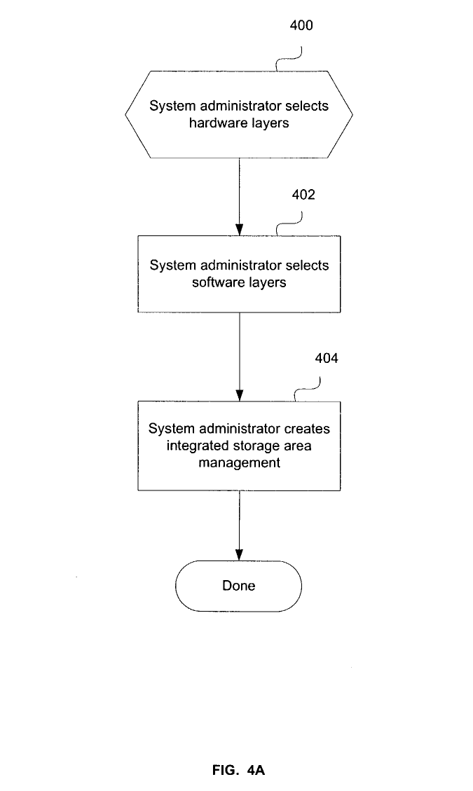

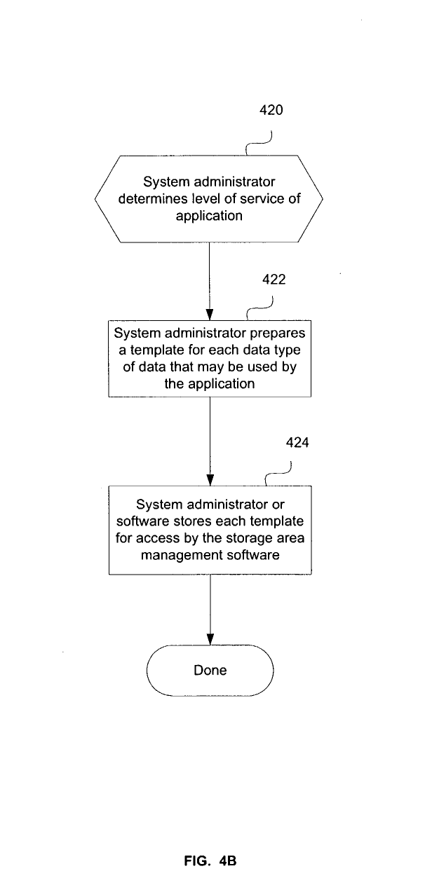

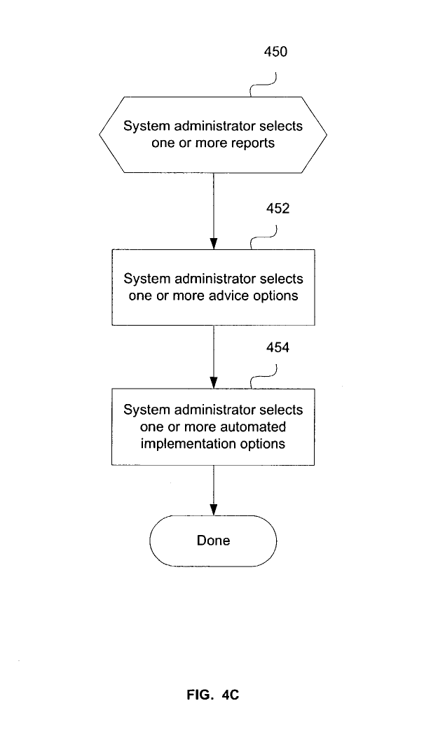

FIGS. 4A, 4B, and 4C illustrate processing performed by a system administrator in accordance with certain implementations of the invention. In FIG. 4A, control begins at block 400 with a system administrator (or other individual) selecting hardware layers 230 (e.g., the hardware layers 230 illustrated in FIG. 2). In block 402, the system administrator selects software layers 220 (e.g., the software layers 220 illustrated in FIG. 2). In block 404, the system administrator creates an integrated storage area management system 200 by integrating the software and hardware layers 220, 230, respectively. Integration of the software and hardware layers 220, 230, respectively, refers to the definition and deployment of hardware or of a software service. The software and hardware layers 220, 230, respectively, are integrated by standard techniques. For example, one or more applications 202 are installed, a file system 204 is installed, and a selected operating system 206 is installed. Additionally, the storage systems 210 are physically connected to the storage networks 208.

In FIG. 4B, control begins at block 420 in FIG. 4B with a system administrator determining a level of service for an application 110, 140. The determination of the level of service may be based upon business policies (e.g., database applications receive a certain level of service), based upon service level agreements that specify the level of service, or other factors. The level of service may indicate, for example, that an application is to receive a high level of service (e.g., high performance storage).

Upon determining the level of service, the system administrator creates a template for each data type of data that may be used by the application 110, 140 (block 422). Each template provides information on the type of resources that are to be associated with the data type. In certain implementations, a custom template is created for each data type. In certain implementations, a set of templates are predefined, and each predefined template is associated with a certain level of service for a data type. For example, each template may have a designation such as a color (e.g., platinum, gold, silver, or bronze) or a number (e.g., 1, 2, 3, or 4) that identifies the level of service represented by that template. For instance, a platinum template may be associated with a higher level of service than a bronze template. When sets of templates are predefined, the system administrator may associate a predefined template with a data type. In certain implementations, the system administrator may also customize the predefined templates. In certain implementations, a template is created for each data type for each application 110, 140. For example, one application 110, 140 may have a first template associated with a database log data type, while another application 110, 140 has a second template associated with the database log data type.

Once a template is selected and/or customized, the template is stored (e.g., by the system administrator or by software 130) in an area that is accessible by the storage area management software 130 (block 424).

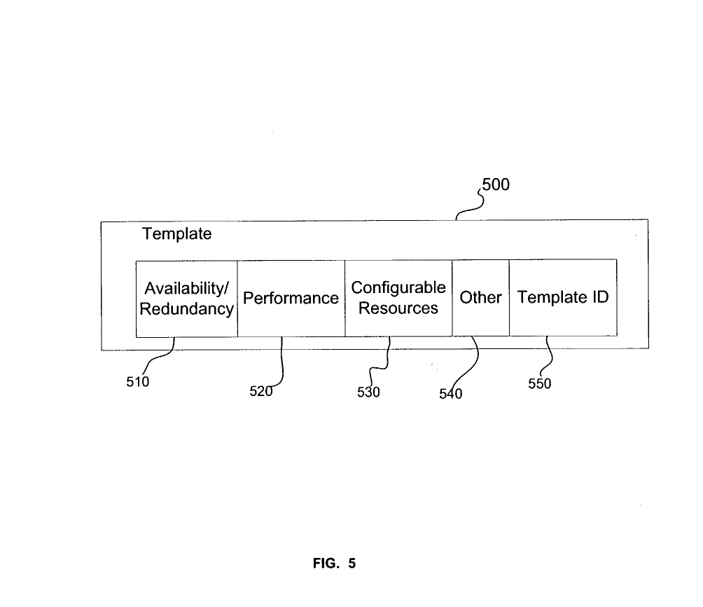

FIG. 5 illustrates a sample template 500 in accordance with certain implementations of the invention. The template 500 includes an “availability/redundancy” field 510, which indicates the redundancy level of a resource. The term “redundancy level” refers to the extent to which failure can be tolerated while a device still functions. For instance, for storage devices, the data redundancy level would indicate the number of copies of data which can be accessed in case of failure, thus increasing availability. For instance, the availability service attribute may specify for a storage device “no single point of failure”, which can be implemented by using redundant storage device components to ensure continued access to the data in the event of a failure of a percentage of the storage devices. Note, that there is a direct correlation between redundancy and availability in that, for instance, the greater the number of redundant instances of a storage device, the greater the chances of data availability in the event that one storage device instance fails. For switches, host bus adaptors and other resources, the availability/redundancy may indicate the extent to which redundant instances of the resources, or subcomponents therein, are provided with the configuration. The “performance” field 520 indicates the performance of the resource. For instance, if the resource is a switch, the “performance” field 520 would indicate the throughput of the switch; if the resource is a storage device, the “performance” field 520 may indicate the I/O throughput. The “configurable resources” field 530 indicates those particular resource instances, e.g., specific host bus adaptors (HBAs), switches, and storage devices, that are capable of being configured by a template to provide the requested performance and availability/redundancy attributes specified in the fields 510 and 520. The “other” field 540, which is optional, indicates that one or more other performance related attributes, e.g., latency may be included in the template. The “template ID” field 550 provides a unique identifier of the template. The template may also include other information, such as information that assists with implementing business policies (e.g., certain applications 110, 140 are not allowed to have more than some specified amount of resources for an extended period of time). The information for the template may be obtained by having the system administrator provide input for the template through, for example, a user interface.

In certain implementations, the storage area management software 130 enables a system administrator (or other individual) to customize the storage area management software 130. That is, a system administrator may use storage area management software 130, via a user interface, for example, to select particular reports, to indicate whether advice is requested, and to indicate whether actions may be automatically implemented by the software 130. Control begins at block 450 in FIG. 4C with a system administrator (or other individual) selecting one or more reports. In certain implementations, predefined reports are provided that act as standard reports that are selected via a user interface to software 130. In certain implementations, reports may be custom built by a system administrator. In certain implementations, standard reports may be customized.

In certain implementations, the system administrator identifies how often or when reports should be generated. For example, one report option allows reports to be automatically generated under specified conditions (e.g., upon receipt of a request for storage from an application) and another report option specifies that no reports are to be generated.

In block 452, the system administrator selects one or more advice options (e.g., for customizing an advisor 304). For instance, one advice option allows for selection of the advisor to automatically provide advice under specified conditions (e.g., upon receipt of a request for storage from an application) and another advice option specifies that the system administrator does not want advice.

In block 454, the system administrator selects one or more automated action implementation options (e.g., options for customizing a policy expert 302). For example, one automated action implementation option allows for actions to be automatically implemented without receiving a request, and another automated action implementation option specifies that the system administrator does not want the policy expert to automatically implement actions. In this manner, a system administrator is able to determine how much of the processing of an application's request should be automated.

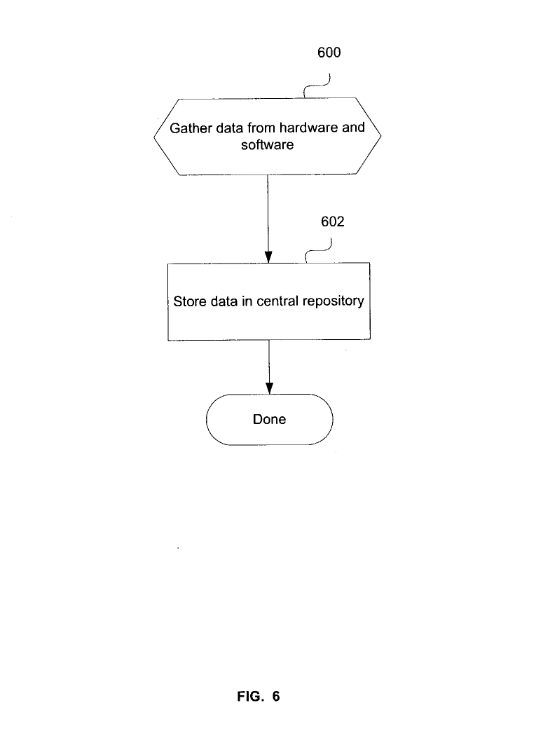

FIG. 6 illustrates logic implemented by the storage area management software 130 to collect data in accordance with certain implementations of the invention. Control begins at block 600 with the storage area management software 130 gathering data from software and hardware. In block 602, the data is stored in the central repository 308. In certain implementations, the reporter 306 performs the gathering and storing of data. The data is gathered, for example, by requesting data from hardware components (e.g., via a device interface 162, 172) or from retrieving metadata files that contain information on software and hardware. In certain implementations, the functionality performed in blocks 600 and 602 is implemented in a collector 307.

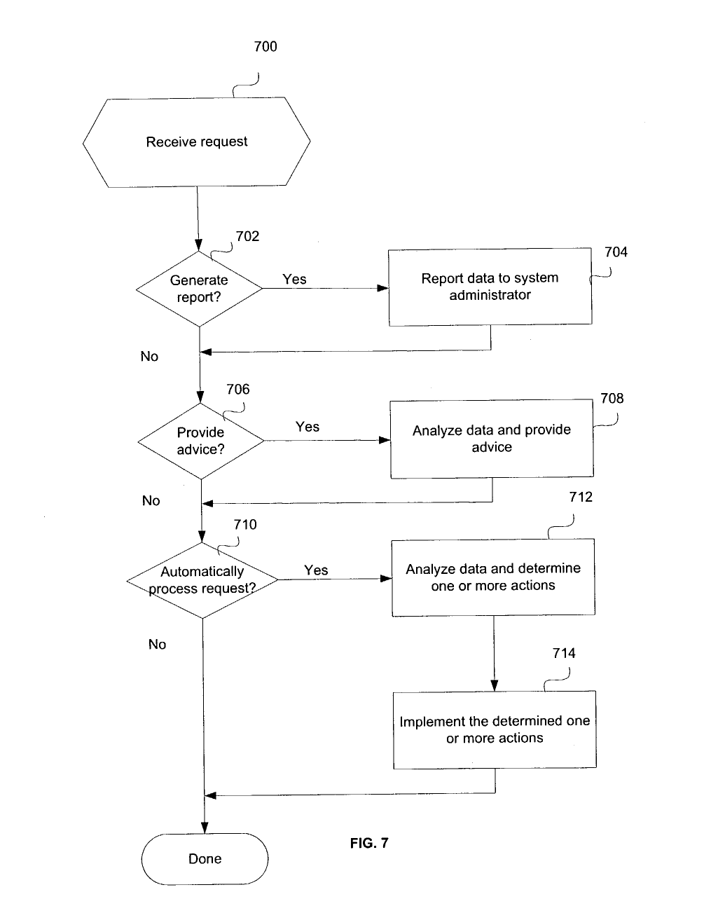

FIG. 7 illustrates logic implemented by the storage area management software 130 to support application level storage management in accordance with certain implementations of the invention. Control begins at block 700 with receipt of a request. The request may be a request from an application 110, 140 for additional storage. In certain implementations, even after selecting options, or instead of selecting options, a system administrator may submit a request (e.g., for a report on the status of storage and/or for advice) related to a particular application. If options have been selected, and, for example, if an advice option was set to indicate that advice is not desired, then a system administrator may submit a request for advice. In certain implementations, a request from a system administrator is received through a user interface.

In block 702, it is determined whether a report is to be generated. If so, processing continues to block 704, otherwise, processing continues to block 706. In block 704, data is reported to a system administrator (e.g., by generating a report). In certain implementations, the functionality performed in block 704 is implemented in a reporter 306.

In block 706, it is determined whether advice is to be provided. For example, advice on how to respond to an applications request for storage may be provided. If so, processing continues to block 708, otherwise, processing continues to block 710.

In certain implementations, the functionality performed in block 708 is implemented in advisor 304. In block 708, the advisor 304 analyzes data and provides advice to the system administrator. The advisor 304 uses the gathered data to determine which hardware and/or software is available that most closely fits with the characteristics identified in the template associated with a data type for the application and with the request. In certain implementations, a set of attributes may be associated with a storage resource (e.g., a storage device 160, 170). In this case, the application is associated with the storage resource by matching the level of service for a data type of data used by the application to the set of attributes of the storage resource.

Then, the advisor 304 provides advice based on the determination. For example, if database software requested additional storage, the advisor 304 may provide a list of five hardware and/or software choices (e.g., choices of potential storage and/or data services) for responding to the request. The advisor 304 may attempt to match the gathered data to the characteristics to identify the hardware and/or software choices. For example, if the gathered data indicates that there is first storage with a high level of protection and second storage with a low level of protection, and the characteristics require a high level of protection, the advisor may select the first storage as a choice to recommend, depending on other characteristics identified in the template.

In block 710, it is determined whether the request is to be automatically processed. If so, processing continues to block 712, otherwise, processing is done. In certain implementations, the functionality performed in blocks 712 is implemented in a policy expert 302. In block 712, the policy expert 302 analyzes data and selects one or more actions. In particular, if advice was not requested and the advisor did not analyze the data and provide advice (block 708), the policy expert 302 analyzes the data. In certain implementations, the policy expert 302 may call the advisor 304 to analyze the data. If the advisor did analyze the data and provide advice, the policy expert 302 may perform additional analysis to determine which choice from the advice is best to implement in light of the characteristics identified in the template. Then, the policy expert 302 implements the determined one or more actions based on the analysis (block 714). For example, the policy expert may configure one or more of the data services 318. The term “configure” refers to automatically setting configuration settings for a data service. For example, if the data service is a backup operation to backup data, the policy expert may determine how frequently the backup operation should occur and identify the source and targets of the backup operation.

The described techniques for maintaining information on network components may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which described embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

Although implementations of the invention describe an individual customizing software 130, in certain implementations, an application may customize software 130.

The logic of FIGS. 4A, 4B, 4C, 6, and 7 describes specific operations occurring in a particular order. In alternative implementations, certain of the logic operations may be performed in a different order, modified or removed. Morever, steps may be added to the above described logic and still conform to the described implementations. Further, operations described herein may occur sequentially or certain operations may be processed in parallel, or operations described as performed by a single process may be performed by distributed processes.

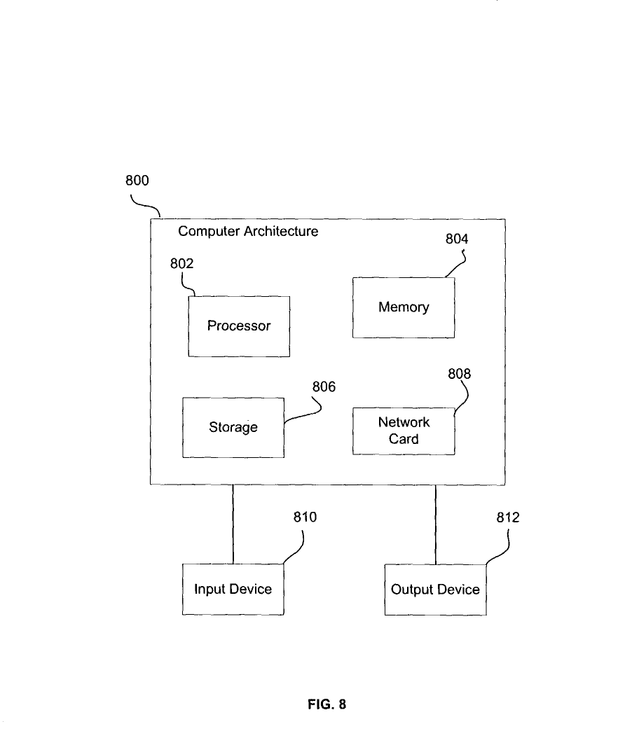

FIG. 8 illustrates one implementation of the architecture of the computer systems 100 and 120 in accordance with certain implementations of the invention. The computer systems 100 and 120 may implement a computer architecture 800 having a processor 802 (e.g., a microprocessor), a memory 804 (e.g., a volatile memory device), and storage 806 (e.g., a non-volatile storage, such as magnetic disk drives, optical disk drives, a tape drive, etc.). The storage 806 may comprise an internal storage device or an attached or network accessible storage. Programs in the storage 806 are loaded into the memory 804 and executed by the processor 802 in a manner known in the art. The architecture further includes a network card 808 to enable communication with a network. An input device 810 is used to provide user input to the processor 802, and may include a keyboard, mouse, pen-stylus, microphone, touch sensitive display screen, or any other activation or input mechanism known in the art. An output device 812 is capable of rendering information transmitted from the processor 802, or other component, such as a display monitor, printer, storage, etc.

The foregoing description of implementations of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many implementations of the invention can be made without departing from the spirit and scope of the invention, the invention resides in the claims hereinafter appended.

Sun and StorEdge are registered trademarks or trademarks of Sun Microsystems, Inc. in the United States and/or other countries. InfiniBand is a registered service mark or service mark of the InfiniBand Trade Association in the United States and/or other countries.

What is claimed is:

1. A method for supporting an application, comprising:
integrating software and hardware layers to form an integrated storage area management system;
determining a level of service for the application;
creating a template for each data type of data used by the application, wherein each template identifies characteristics associated with the level of service for the application;
gathering data from the software and hardware layers; and
processing requests from the application using the gathered data.

2. The method of claim 1, wherein integrating further comprises at least one of selecting software layers and selecting hardware layers.

3. The method of claim 1, further comprising at least one of:
generating a report based on the gathered data; and
generating one or more choices based on the gathered data and the characteristics identified in one or more of the templates to respond to a request for advice.

4. The method of claim 3, wherein generating one or more choices further comprises at least one of matching the characteristics to the gathered data to identify hardware choices and matching the characteristics to the gathered data to identify software choices.

5. The method of claim 1, further comprising:
analyzing the gathered data and implementing one or more actions based on the characteristics identified in one or more of the templates and results of the analysis of the gathered data in response to a request that one or more actions be automatically implemented.

6. The method of claim 1, wherein analyzing the gathered data and implementing one or more actions further comprises at least one of:
requesting advice and receiving a list of choices;
selecting a choice from a provided list of choices; and
implementing one or more actions for a selected choice.

7. The method of claim 6, wherein implementing one or more actions further comprises:
configuring one or more data services.

8. The method of claim 1, wherein gathering data further comprises:
gathering data from hardware regarding storage availability.

9. The method of claim 1, wherein the application comprises at least one of a client application and a server application.

10. The method of claim 1, wherein the characteristics comprise at least one of availability and redundancy characteristics, performance characteristics, and security characteristics.

11. The method of claim 1, wherein gathering data on software and hardware further comprises:
gathering data from one or more integrated storage area management system levels.

12. The method of claim 1, further comprising at least one of:
receiving selection of one or more report options from a system administrator;
receiving selection of one or more advice options from a system administrator; and
receiving selection of one or more automated action implementation options from a system administrator.

13. The method of claim 1, wherein each of multiple instances of data of a particular data type is associated with the template associated with the particular data type.

14. The method of claim 1, wherein the data type is associated with a first template for a first application and the data type is associated with a second template for a second application.

15. A method for supporting a level of service for an application, comprising:
creating a template for each data type of data used by the application, wherein each template identifies characteristics associated with the level of service for the application;
gathering data on software and hardware;
generating one or more choices based on the gathered data and the characteristics identified in one or more of the templates to respond to a request for advice; and
analyzing the gathered data and implementing one or more actions based on the characteristics identified in one or more of the templates and results of the analysis of the gathered data in response to a request that one or more actions be automatically implemented.

16. The method of claim 15, further comprising at least one of:
generating a report based on the gathered data; and
at least one of matching the characteristics to the gathered data to identify hardware choices and matching the characteristics to the gathered data to identify software choices.

17. The method of claim 15, wherein analyzing the gathered data and implementing one or more actions further comprises at least one of:
requesting advice and receiving a list of choices;
selecting a choice from a provided list of choices; and
implementing one or more actions for a selected choice.

18. The method of claim 17, wherein implementing one or more actions further comprises:
configuring one or more data services.

19. The method of claim 15, wherein gathering data further comprises:
gathering data from hardware regarding storage availability.

20. The method of claim 15, wherein the application comprises one at least one of a client application and a server application.

21. The method of claim 15, wherein the characteristics comprise at least one of availability and redundancy characteristics, performance characteristics, and security characteristics.

22. The method of claim 15, wherein gathering data on software and hardware further comprises:
gathering data from one or more integrated storage area management system levels.

23. The method of claim 15, further comprising at least one of:
receiving selection of one or more report options from a system administrator;
receiving selection of one or more advice options from a system administrator; and
receiving selection of one or more automated action implementation options from a system administrator.

24. The method of claim 15, wherein each of multiple instances of data of a particular data type is associated with the template associated with the particular data type.

25. The method of claim 15, wherein the data type is associated with a first template for a first application and the data type is associated with a second template for a second application.

26. The method of claim 15, further comprising:
integrating software and hardware layers to form an integrated storage area management system.

27. The method of claim 26, wherein integrating further comprises at least one of selecting software layers and selecting hardware layers.

28. A system for supporting an application, comprising:
an integrated storage area management system that includes hardware layers integrated with software layers;
a storage area for storing one or more templates, wherein each template is associated with a data type of data used by the application, wherein each template identifies characteristics associated with a level of service for the application;
means for gathering data from the hardware layers and software layers;
means for generating one or more reports from the gathered data;
means for generating one or more choices based on the gathered data and the characteristics identified in one or more of the templates to respond to a request for advice; and
means for analyzing the gathered data and implementing one or more actions based on the characteristics identified in one or more of the templates and results of the analysis of the gathered data in response to a request that one or more actions be automatically implemented.

29. The system of claim 28, wherein means for generating one or more choices further comprises at least one of means for matching the characteristics to the gathered data to identify hardware choices and means for matching the characteristics to the gathered data to identify software choices.

30. The system of claim 28, wherein means for analyzing the gathered data and implementing one or more actions further comprises at least one of:
means for requesting advice and receiving a list of choices;
means for selecting a choice from a provided list of choices; and
means for implementing one or more actions for a selected choice.

31. The system of claim 30, further comprising:
data services; and
means for configuring the data services to perform one or more actions.

32. The system of claim 28, wherein means for gathering data further comprises:
means for gathering data from hardware regarding storage availability.

33. The system of claim 28, wherein the application comprises at least one of a client application and a server application.

34. The system of claim 28, wherein the characteristics comprise at least one of availability and redundancy characteristics, performance characteristics, and security characteristics.

35. The system of claim 28, wherein means for gathering data further comprises:
means for gathering data from one or more integrated storage area management system levels.

36. The system of claim 28, further comprising at least one of:
means for receiving selection of one or more report options from a system administrator;
means for receiving selection of one or more advice options from a system administrator; and
means for receiving selection of one or more automated action implementation options from a system administrator.

37. The system of claim 28, wherein each of multiple instances of data of a particular data type is associated with the template associated with the particular data type.

38. The system of claim 28, wherein the data type is associated with a first template for a first application and the data type is associated with a second template for a second application.

39. An article of manufacture for supporting a level of service for an application, wherein the article of manufacture is capable of causing operations, the operations comprising:
gathering data on software and hardware;
generating one or more choices based on the gathered data and the characteristics identified in one or more templates to respond to a request for advice, wherein each template is associated with a data type of data used by the application and wherein each template identifies characteristics associated with the level of service for the application; and
analyzing the gathered data and implementing one or more actions based on the characteristics identified in one or more of the templates and results of the analysis of the gathered data in response to a request that one or more actions be automatically implemented.

40. The article of manufacture of claim 39, wherein the operations for generating one or more choices further comprise at least one of:
generating a report based on the gathered data; and
at least one of matching the characteristics to the gathered data to identify hardware choices and matching the characteristics to the gathered data to identify software choices.

41. The article of manufacture of claim 39, wherein the operations for analyzing the gathered data and implementing one or more actions further comprise at least one of:
requesting advice and receiving a list of choices;
selecting a choice from a provided list of choices; and
implementing one or more actions for a selected choice.

42. The article of manufacture of claim 43, wherein the operations for implementing one or more actions further comprise:
configuring one or more data services.

43. The article of manufacture of claim 39, wherein the operations further comprise:
gathering data from hardware regarding storage availability.

44. The article of manufacture of claim 39, wherein the application comprises at least one of a client application and a server application.

45. The article of manufacture of claim 39, wherein the characteristics comprise at least one of availability and redundancy characteristics, performance characteristics, and security characteristics.

46. The article of manufacture of claim 39, wherein the operations for gathering data on software and hardware further comprise:
gathering data from one or more integrated storage area management system levels.

47. The article of manufacture of claim 39, wherein the operations further comprise at least one of:
receiving selection of one or more report options from a system administrator;
receiving selection of one or more advice options from a system administrator; and
receiving selection of one or more automated action implementation options from a system administrator.

48. The article of manufacture of claim 39, wherein each of multiple instances of data of a particular data type is associated with the template associated with the particular data type.

49. The article of manufacture of claim 39, wherein the data type is associated with a first template for a first application and the data type is associated with a second template for a second application.
